(19) United States
(12) Patent Application Publication
(10) Pub. No.: US 2026/0289570 A1
(43) Pub. Date: Sep. 24, 2026

(54) SYSTEMS AND METHODS FOR TRANSACTION-TRIGGERED ISSUANCE AND AUTOMATED ROTATION OF VIRTUAL PAYMENT CARDS TO PREVENT PAYMENT FRAUD

(71) Applicant: Secure Purchase LLC, Clearwater, FL (US)

(72) Inventor: Stephen Pashoian, Clearwater, FL (US)

(21) Appl. No.: 19/458,411

(22) Filed: Jan. 23, 2026

Related U.S. Application Data
(60) Provisional application No. 63/776,819, filed on Mar. 24, 2025.

(51) Int. Cl. G06Q 20/40; G06Q 20/34; G06Q 20/38

(52) U.S. Cl. CPC G06Q 20/4016; G06Q 20/351; G06Q 20/3821

(57) ABSTRACT

Systems and methods are for preventing payment fraud using transaction-triggered issuance and automated rotation of virtual payment card credentials. A system maintains a secure association between a user account and underlying payment credentials issued by financial institutions. The system generates a randomized virtual payment card credential and transmits the same for use at a payment interface. Upon completion of an authorized transaction or satisfaction of a predefined usage condition, the randomized virtual payment card credential is automatically invalidated to prevent reuse. A replacement randomized virtual payment card credential is generated without user intervention. The security codes associated with the randomized credential are dynamically regenerated at predefined time intervals. The systems improve electronic payment security by limiting credential reuse, reducing exposure of underlying account information, and providing automated credential lifecycle management across cashless payment environments.

### CROSS REFERENCE TO RELATED APPLICATIONS

This application claims priority from a U.S. Provisional Patent Appl. No. 63/776,819,filed on Mar. 24, 2025, which is incorporated herein by reference in its entirety.

### FIELD OF INVENTION

The present invention relates generally to electronic payment processing and fraud prevention systems, and more particularly to computer-implemented systems and methods for issuing, managing, and automatically rotating virtual payment cards in response to transaction events, wherein each issued virtual card is configured for single-use or limited-use transactions and is automatically invalidated and replaced after use to reduce fraud risk and unauthorized reuse.

The invention further relates to secure payment credential management, tokenized payment instruments, and real-time integration between payment authorization systems and card issuing platforms, including mobile and network-based applications that present dynamically issued virtual cards to end users for transactional use.

### BACKGROUND

Credit cards, debit cards, and similar payment instruments have long been used as convenient mechanisms for conducting cashless transactions. Such card-based payment systems provide portability, ease of use, and the ability to perform transactions without physical currency. Payment cards may be carried in wallets or accessories, and electronic representations of cards may be stored on mobile devices, digital wallets, or computing platforms. Card usage further enables automated recordkeeping and transaction history management for both users and financial institutions.

With the continued expansion of e-commerce, mobile applications, subscription services, and remote transactions, reliance on card-based payment methods has increased substantially. At the same time, incidents of payment fraud have also increased, particularly in card-not-present transaction environments. Although various security mechanisms such as encryption, tokenization, and authentication protocols have been introduced, card-based fraud remains a significant challenge. Static card numbers, expiration dates, and security codes are frequently reused across multiple transactions and merchants, thereby increasing exposure when such information is compromised.

Many digital platforms, merchants, and payment applications store card credentials or payment tokens in encrypted or obfuscated form. Nevertheless, such stored information may be exposed through cybersecurity events including phishing attacks, malware, unauthorized system access, or data breaches. Once compromised, static or reusable card credentials can be exploited for unauthorized transactions, often without immediate detection, resulting in financial losses and administrative burden for users and issuing entities.

Existing virtual card solutions typically rely on manually generated card numbers, cards with extended validity periods, or cards that remain usable across multiple transactions or merchants. Such approaches may reduce certain risks but do not fully eliminate the exposure associated with reuse of payment credentials, delayed invalidation, or reliance on user-initiated controls. As a result, unauthorized reuse, replay attacks, and credential leakage continue to present vulnerabilities in conventional payment systems.

Accordingly, there is a need for improved systems and methods that enhance the security of card-based cashless payments by minimizing the availability and reuse of sensitive payment credentials. In particular, there is a need for automated, transaction-driven solutions capable of issuing dynamic virtual payment cards that are invalidated after use or upon satisfaction of predefined conditions, without requiring manual user intervention, and that thereby reduce the risk of fraud and unauthorized transactions.

### SUMMARY OF THE INVENTION

The following provides a simplified summary of one or more embodiments of the present invention to facilitate a basic understanding of its features and advantages. This summary is not an exhaustive overview of all contemplated embodiments and is not intended to identify essential elements or define the full scope of the invention. It merely introduces certain concepts that are described in greater detail in the subsequent sections.

The principal object of the present invention is to provide a computer-implemented system and method for generating randomized virtual payment card information for use in cashless payment transactions.

Another object of the present invention is to reduce payment fraud and unauthorized use by automatically randomizing and rotating virtual card information after each transaction or upon satisfaction of predefined usage conditions.

Another object of the present invention is to enhance user confidence and assurance during electronic payment transactions by minimizing exposure of sensitive payment credentials.

Another object of the present invention is to reduce economic loss associated with payment fraud, card misuse, and unauthorized transactions.

Another object of the present invention is to improve user privacy and transaction security by preventing disclosure of primary account information to merchants, third parties, or unauthorized entities.

Another object of the present invention is to securely isolate and protect a user's underlying financial account information such that vendors, intermediaries, or malicious actors are unable to view or access primary account credentials.

Another object of the present invention is to substantially reduce the risk of credit card fraud and identity theft by limiting the reuse, validity, and exposure duration of virtual payment credentials.

Another object of the present invention is to provide a unified application interface through which a user may access and manage multiple financial accounts without the need to carry multiple physical cards, use multiple applications, or memorize multiple credentials.

Another object of the present invention is to enable payments from multiple funding sources using a single payment card or mobile application.

Another object of the present invention is to enable secure transactions at a wide range of retail points of sale, including in-person, online, and remote transaction environments.

The present invention provides computer-implemented systems and methods for preventing payment fraud through transaction-triggered issuance and automated rotation of virtual payment card credentials. The disclosed invention addresses technical shortcomings of conventional card-based payment systems by limiting exposure, validity, and reuse of payment credentials at a system level.

In accordance with one embodiment, a system maintains a secure association between a user master account and one or more original payment credentials issued by a financial institution. Prior to initiation of a payment transaction, the system generates a randomized virtual payment card credential distinct from the original payment credential. The randomized virtual payment card credential includes at least a virtual card number and a security code and is configured for use in place of the original payment credential at a point-of-sale or digital payment interface.

The randomized virtual payment card credential is associated with one or more transaction constraints, such as a transaction amount or a usage count, which govern authorization of the transaction. Upon detection of execution and completion of an authorized transaction, the system automatically invalidates the randomized virtual payment card credential responsive to satisfaction of at least one transaction constraint, thereby preventing reuse of the credential.

In some embodiments, the randomized virtual payment card credential is configured for single-use only. In other embodiments, the randomized virtual payment card credential may be cryptographically bound to a merchant identifier or other transaction-specific parameter to further restrict unauthorized use prior to invalidation.

In certain embodiments, a security code associated with the randomized virtual payment card credential is automatically regenerated at recurring predefined time intervals prior to invalidation, thereby reducing the risk of interception or misuse during the authorization window.

Following invalidation of a randomized virtual payment card credential, the system automatically generates a replacement randomized virtual payment card credential without requiring user intervention. This automated credential lifecycle management enables continuous secure payment capability while minimizing exposure of underlying payment credentials.

In accordance with additional embodiments, the present invention provides corresponding computer-implemented methods and non-transitory computer-readable media implementing the disclosed functionality. By dynamically generating, constraining, invalidating, and replacing virtual payment card credentials in response to transaction events, the disclosed systems and methods provide a technical improvement to electronic payment security and fraud prevention.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram illustrating an operating environment of a transaction-triggered virtual payment card system, according to an exemplary embodiment of the present invention.

FIG. 2 is a block diagram illustrating an internal architecture of the system for issuing and automatically rotating virtual payment cards, according to an exemplary embodiment of the present invention.

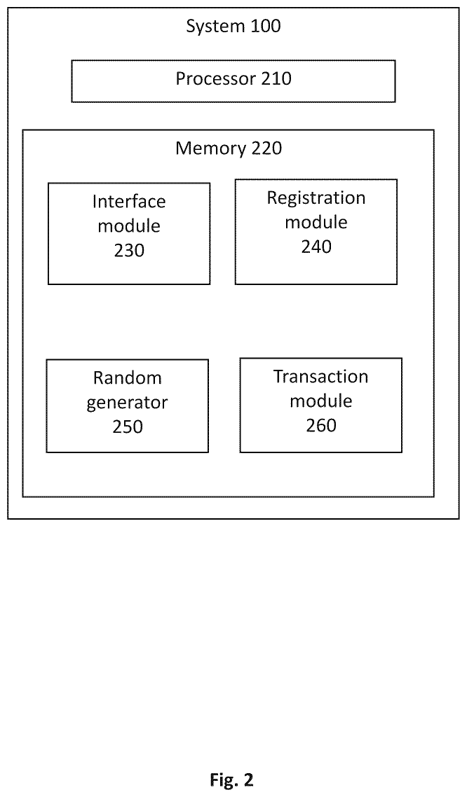

FIG. 3 illustrates a registration user interface screen for enrolling a user with the system, according to an exemplary embodiment of the present invention.

FIG. 4 illustrates a login user interface screen for authenticating a user to access the system, according to an exemplary embodiment of the present invention.

### DETAILED DESCRIPTION

The subject matter of the present invention will now be described more fully with reference to the accompanying drawings, which form a part of this disclosure and illustrate specific exemplary embodiments. However, it should be understood that the subject matter may be embodied in various forms and is not limited to the specific embodiments set forth herein. Rather, these embodiments are provided by way of example to convey the scope of the invention. It is intended that the claims encompass a broad range of subject matter, including methods, devices, components, and systems. Accordingly, the following detailed description is not intended to be taken in a limiting sense.

As used herein, the term “exemplary” is intended to mean “serving as an example, instance, or illustration.” Any embodiment described as “exemplary” should not be construed as preferred or more advantageous over other embodiments. Similarly, the expression “embodiments of the present invention” does not imply that all embodiments must include all features, advantages, or modes of operation described.

The terminology used herein is for the purpose of describing particular embodiments only and is not intended to be limiting. As used herein, the singular forms “a,” “an,” and “the” include plural references unless the context clearly dictates otherwise. Furthermore, the terms “comprises,” “comprising,” “includes,” and/or “including” specify the presence of stated features, integers, steps, operations, elements, or components, but do not preclude the presence or addition of one or more other features, integers, steps, operations, elements, components, and/or groups thereof.

The following detailed description sets forth the best currently contemplated modes for carrying out exemplary embodiments of the invention. This description is not intended to be limiting, but rather to illustrate the general principles of the invention. The claims of any issued patent will define the scope of the invention.

The present invention pertains to systems and methods for generating randomized virtual payment card information for use in cashless payment transactions. The randomized card information is configured to be used in place of original card credentials associated with a user's underlying financial account. In accordance with the disclosed embodiments, new randomized card information may be generated after one or more transactions. In a preferred embodiment, new randomized card information is generated after each transaction and is configured for use only in authorized payment transactions. By substituting randomized card information for original card credentials, the risk of exposure, leakage, or misuse of sensitive account information is substantially reduced. Automatic regeneration of randomized card information after each transaction or after a defined number of transactions further limits unauthorized reuse and enhances transaction security.

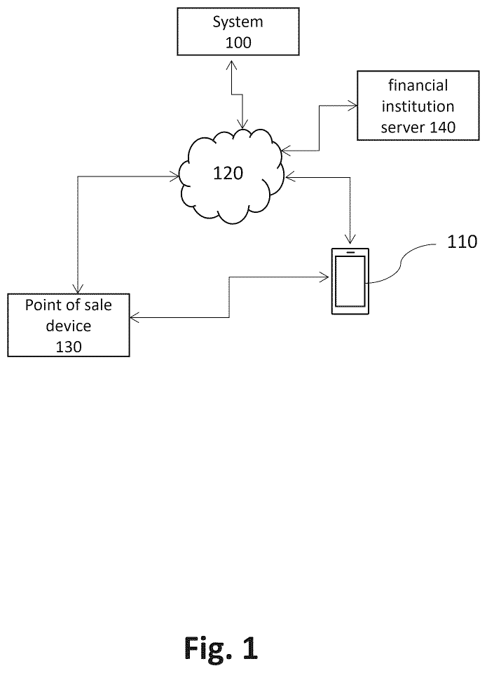

Referring to FIG. 1, an operating environment of the disclosed system 100 is illustrated. The system 100 is configured to communicate with one or more user devices 110 via a network 120. As used herein, the term “user” refers to an individual operating a user device to interact with the system for generating and using randomized virtual card information. The user device 110 may include any computing device having a processor and memory for executing instructions. The user device may further include one or more input components for receiving user input, such as a touchscreen, keyboard, mouse, stylus, or touchpad, and one or more output components, such as a display screen. The user device may also include network communication circuitry for connecting to the network 120. Non-limiting examples of user devices include smartphones, desktop computers, laptop computers, workstations, and tablet devices.

The network 120 may include one or more wired or wireless communication networks known in the art, including but not limited to a local area network (LAN), wide area network (WAN), wireless LAN (WLAN), metropolitan area network (MAN), cellular data network, cellular voice network, or the Internet. A user device may connect to the system 100 through one or more networks, and different user devices may connect to the system through different networks.

The system 100 may further communicate with one or more point-of-sale (POS) devices 130 via the network 120. The POS device 130 may include any physical or digital payment interface through which a transaction is initiated, authorized, and completed. The system 100 may also communicate with one or more financial institution servers 140, which may include card issuers, banks, or payment processors associated with original payment cards.

System 100 includes a processor 210 and a memory 220 operably coupled to the processor. The processor can be any logic circuitry that responds to, and processes instructions fetched from the memory. The memory may include one or more memory chips capable of storing data and allowing any storage location to be directly accessed by the processor. The memory can include modules according to the present invention for execution by the processor to perform one or more steps of the disclosed methodology.

The memory 220 may store one or more modules executable by the processor 210, including an interface module 230 for rendering a user interface on the user device, a registration module 240 for registering and managing user accounts, a random card generation module 250 for generating randomized virtual card information, and a transaction module 260 for authenticating, authorizing, and executing payment transactions using the randomized card information.

The term module as used herein and throughout this disclosure refers to software, a program code, a set of rules or instructions, and the like in one or more computer-readable languages including graphics, which upon execution by the processor performs one or more steps of the disclosed methodology. Also, operations may be described as a sequential process, some of the operations may be performed in parallel, concurrently, and/or in a distributed environment, and with program code stored locally or remotely for access by single or multi-processor machines. In addition, in some implementations, the order of operations may be rearranged without departing from the spirit of the disclosed subject matter.

The system can be implemented in the form of servers, which include cloud servers. The servers can be placed in one location or geographically dispersed. Also, one or more steps of the disclosed methodology can be performed on one or more user devices without departing from the spirit of the disclosed subject matter.

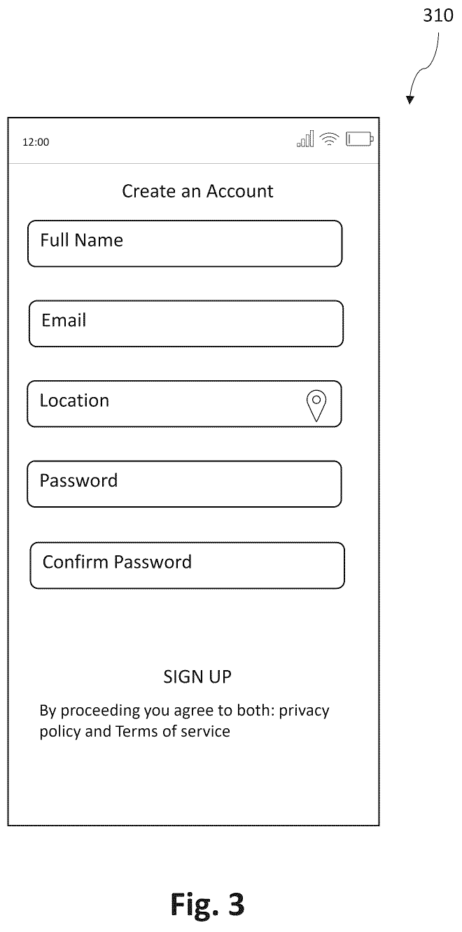

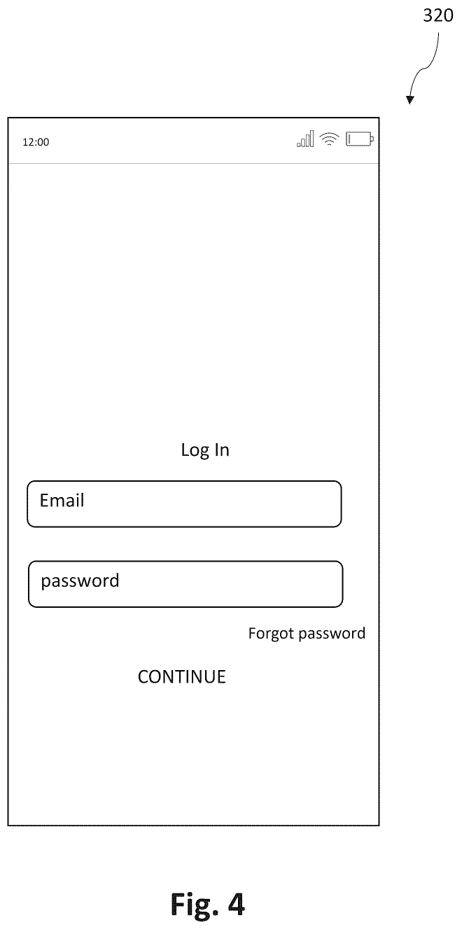

The interface provided by the interface module allows a user to interact with the disclosed system through a user device. The interface may include a series of screens, as shown in FIGS. 3-4, which in continuation can provide information as well as receive information from the user and execute one or more steps of the disclosed methodology. The interface can be dynamic and allows switching between sections, screens, pages, and the like quickly and easily. The interface can be provided by application software that can be installed on the user device. The application software can be developed for Android™, iOS, and any other known operating platform for mobile devices. The application software can be made available through a distribution service provider, for example, Google Play™ operated and developed by Google™, and the App store™ by Apple™. In addition to the application software, a website-based interface can also be provided through the World Wide Web. The application software can also be provided for the desktop environment, such as Windows™, Linux™, and macOS™. The user interface may permit interaction with a user through the user device, wherein information can be presented within the user interface by system 100 and information can be received by system 100 from the user.

The registration module may allow an individual willing to use the disclosed system to register. The user module can receive basic information about the individual, such as name, contact details, email address, and the like. The user module can generate a profile for the user and store the same in a suitable database. The databases, including their structure and functioning, are known in the art. Also, the use of blockchain databases is well known. The present invention can use any suitable database without departing from the scope of the present invention. Also, the profile created by the user module can be later modified by the user. FIG. 3 shows a registration screen 310 and FIG. 4 shows a login screen 320. The user module can generate login details to access the disclosed system securely. The login details may include at least a username and a password. The password can be an alphanumeric code, or biometric like a fingerprint, token, and the like. The user may have multiple login options, such as using an alphanumeric code or a fingerprint. Also, the use of multiple-factor authentication is within the scope of the present invention. The user can be provided with a login screen on the user device for accessing the disclosed system.

Once the user may be registered and optionally verified for identity, as per any prescribed guidelines of a state, the system may create a master account for the user. The master account may be associated with one or more original payment cards, such as credit or debit cards, issued by one or more financial institutions. The user may add all the information to allow the system to execute a payment transaction without user's intervention. The system may, for security reasons, verify the ownership of the card. For example, the system may request the card number, CVV, and expiry date, all that may be needed to process a transaction. Also, in some cases, the user may request the financial institution to authorize the system to use the card for executing autonomous transactions on behalf of the user.

After registration and optional identity verification, the system may create a master account for the user. The master account may be associated with one or more original payment cards, such as credit or debit cards, issued by one or more financial institutions. The system may verify ownership of the original payment cards using information such as card number, expiration date, security code, or issuer-based authorization.

Upon successful association of an original payment card with the master account, the random card generation module 250 generates a randomized virtual card corresponding to the original card. The randomized virtual card may include a virtual card number, expiration date, and security code generated independently of the original card credentials. The randomized virtual card may be presented at a point-of-sale device or digital payment interface for conducting payment transactions.

When the user presents the random card information at the point-of-sale device or digital payment interface, the point-of-sale device trough suitable network may communicate with the disclosed system for verification and execution of the transaction. Upon verification, the system initiates the transaction using the original card credentials with the associated financial institution server. Once authorization is received, the system transmits approval to the POS device and records the transaction in association with the randomized virtual card.

In some embodiments, multiple original payment cards may be associated with a single master account, enabling the user to select among multiple funding sources.

In some embodiments, the system allows the user to define a usage limit for each randomized virtual card, referred to herein as a usage cycle number. The usage cycle number specifies how many transactions the randomized virtual card may be used for. When the usage cycle number is set to one, the randomized virtual card is single-used and is automatically invalidated after the transaction, after which a new randomized virtual card is generated. The user can set the usage circle number as well as modify the preset usage circle number. Also, instead of or in addition to the usage cycle number, total transactable amount per randomized virtual card can also be set.

In certain implementations, the disclosed system can change the CVV after predetermined duration, for example, 1 min. The CVV number can be randomized after every one minute. The user must use the current CVV number to authenticate a transaction.

In certain embodiments, the system can generate a transaction-specific virtual card credential set comprising up to twenty-three independently variable numeric digits, including portions of the card number, expiration data, and security code. This provides up to 10²³ unique card configurations per transaction, creating a sufficiently large combinatorial space to render credential prediction, reuse, or brute-force enumeration computationally infeasible. Because each virtual card credential is invalidated immediately following authorization, the effective reuse window is reduced to a single transaction, thereby materially eliminating card-not-present fraud risk.

In certain implementations, the disclosed system can be used to protect access to the user portal for their account information except the number of digits available for use are unfathomable. All users'account data stored on servers will also be protected by the same technology with fast-paced, random changes to the access codes and passwords to prevent hacking into the storage facility. With account numbers being used for any purchase and the passwords for those accounts automatically changing after every use, fraud is eliminated. With the user account and the Secure Purchase platform being protected in the same fashion, any potential hacking attempt is eliminated.

In some embodiments, the system may support a physical payment card configured to receive randomized virtual card information. The user interface may provide an option to write the randomized virtual card information onto the physical card using technologies, such as NFC and Bluetooth®. The physical card may include suitable network technologies for receiving information from the authorized user device and store the same. In one case, the interface may display that the user should tap the physical card to the user device for writing the randomized virtual card information to the physical card.

In some embodiments, the physical card may include a selection mechanism allowing the user to switch between multiple stored virtual cards. For example, a button may be activated to switch between multiple stored virtual cards.

In some embodiments, the system may generate a predefined set of randomized virtual cards associated with an original card, wherein the virtual cards are rotated automatically after each transaction or after a defined number of transactions or time period. The system may allow generation of a new set of random cards after a predefined duration. For example, after 15 days, a new set of random cards may be generated.

In certain implementations, the disclosed system may, through the interface, present the transaction history associated with each original card. It is to be noted that the random cards can be used for one or more preset number of transactions, and after which the respective random cards may be achieved. Also, the random cards may have an expiration date, after which the virtual cards may be deleted from the system. The user may however be allowed to take a copy of the virtual cards and associated transactions.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A computer-implemented system for preventing payment fraud through transaction-triggered virtual card rotation, comprising:
a processor;
a non-transitory memory storing instructions that, when executed by the processor, cause the processor to:
maintain a secure association between a user master account and at least one original payment credential issued by a financial institution;
generate, prior to initiation of a payment transaction, a randomized virtual payment card credential distinct from the original payment credential, the randomized virtual payment card credential comprising at least a virtual card number and a security code;
associate the randomized virtual payment card credential with at least one transaction constraint selected from a transaction amount or a usage count;
transmit the randomized virtual payment card credential for use at a point-of-sale or digital payment interface;
detect execution of the payment transaction and automatically invalidate the randomized virtual payment card credential responsive to satisfaction of the at least one transaction constraint indicating completion of an authorized transaction, thereby preventing reuse; and
automatically generate a replacement randomized virtual payment card credential without requiring user intervention,
wherein the system reduces exposure of the original payment credential by limiting validity and reuse of the randomized virtual payment card credential at a system level.

2. The system of claim 1, wherein the randomized virtual payment card credential is configured for single-use only.

3. The system of claim 1, wherein the randomized virtual payment card credential is cryptographically bound to a merchant identifier.

4. The system of claim 1, wherein the security code is automatically regenerated at recurring predefined time intervals prior to invalidation of the randomized virtual payment card credential.

5. A computer-implemented method for secure cashless payment using automated virtual card rotation, the method comprising:
storing, by a processor, an original payment credential associated with a user master account;
generating, by the processor and prior to initiation of a payment transaction, a randomized virtual payment card credential distinct from the original payment credential;
associating the randomized virtual payment card credential with one or more transaction-specific constraints;
authorizing use of the randomized virtual payment card credential for the payment transaction through a payment interface subject to the transaction-specific constraints;
detecting completion of the payment transaction;
automatically invalidating the randomized virtual payment card credential responsive to completion of the payment transaction to prevent reuse; and
generating a new randomized virtual payment card credential for a subsequent transaction,
wherein the method improves computer security by preventing reuse of compromised payment credentials through automated credential lifecycle control.

6. The method of claim 5, wherein the randomized virtual payment card credential is configured for single-use only.

7. The method of claim 5, wherein the randomized virtual payment card credential is cryptographically bound to a merchant identifier.

8. The method of claim 5, wherein the security code is automatically regenerated at recurring predefined time intervals prior to invalidation of the randomized virtual payment card credential.
